(19) United States
(12) Patent Application Publication
(10) Pub. No.: US 2009/0014280 A1
(43) Pub. Date: Jan. 15, 2009

(54) Blow-off sprocket

(76) Inventors: James M. Jeter, Jacksonville, FL (US); Franklin P. Lee, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/214,836

(22) Filed: Jun. 23, 2008

Related U.S. Application Data
(60) Provisional application No. 60/937,059, filed on Jun. 25, 2007.

(51) Int. Cl. B65G 47/34

(52) U.S. Cl. 198/358

(57) ABSTRACT

An improved blow-off system wherein compressed air directed through a nozzle is used to eject individual cans from their support pins, wherein the nozzles move in synchronized manner with the individual cans such that the ejection operation is accomplished without need to stop or slow the processing equipment. The blow-off system has a sprocket, such that the sprocket of the blow-off system can be substituted for an idler or drive sprocket found in the pin chain conveyor system of the processing equipment. Multiple blow-off nozzles are disposed radially from a central distribution manifold, with each nozzle being operated by a dedicated valve. As the cans pass around the sprocket for 90 to 180 degrees, the nozzles are aligned with each can over this entire arc. If a defect is noted such that the can needs to be ejected, the individual nozzle associated with the defective can is activated.

This patent application claims the benefit of U.S. Provisional Patent Application Ser. No. 60/937,059, filed Jun. 25, 2007.

### BACKGROUND OF THE INVENTION

This invention relates generally to the field of devices for removing individual articles being manufactured, decorated or otherwise processed or treated in a continuous flow when certain articles are defective, and more particularly to such a device that removes individual cans during manufacturing, decorating or the like without requiring a halting of the process. Even more particularly, the invention relates to such a device wherein compressed air is used to blow the defective cans off of supporting mandrels or pins.

In the manufacture and decorating of cans or containers, such as for example beer or soda cans, large numbers of cans are brought through various processing equipment at very high speed in single file fashion. For example, in can decorating, i.e., printing, the equipment may operate at speeds of 2000 cans per minute. When a defect in a can or in the printing of the can is detected, the can must be removed from the processing line. Because shutting down the equipment results in significant loss of productivity, automatic means have been developed to eject or remove individual defective cans. One type of automatic can ejection device utilizes compressed air to blow the cans off of the support members retaining the can without need for stopping the processing equipment. However, the known blow-off systems use nozzles that are fixed or stationary relative to the moving cans, which often results in instances where a defective can fails to be removed due to the high operational speed, since a defective can is only present in the blow-off zone for a brief period of time.

It is an object of this invention to provide an improved blow-off system, where the blow-off nozzles are non-stationary and move in synchronized manner with the cans, such that the time available for ejection of a defective can is greatly increased.

### SUMMARY OF THE INVENTION

The invention is in general an improved blow-off system wherein compressed air directed through a nozzle is used to eject individual cans from their support pins, wherein the nozzles move in synchronized manner with the support pins of the individual cans such that the ejection operation is accomplished without need to stop or slow the processing equipment, and such that the ejection operation is much more efficient and reliable. The blow-off system comprises a sprocket, whereby the sprocket of the blow-off system can be substituted for an idler or drive sprocket found in the pin chain conveyor system of the processing equipment. Multiple blow-off nozzles are disposed radially from a central distribution manifold, with each nozzle being operated by a dedicated valve. As the cans pass around the sprocket for 90 to 180 degrees, the nozzles are aligned with each can over this entire arc. If a defect is noted such that the can needs to be ejected, the individual nozzle associated with the defective can is activated.

### BRIEF DESCRIPTION OF THE DRAWINGS

FIG. 1 is a front view of the invention, showing the sprocket in plan view, with only one of the twelve air conduits shown, illustrating both a 90 degree and a 180 degree circuit.

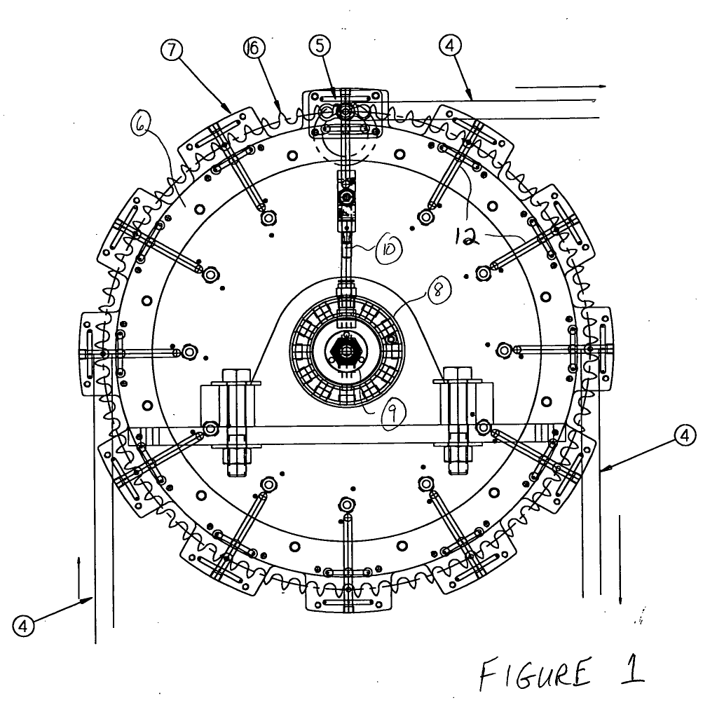

FIG. 2 is a side view of the invention, again with only one of the twelve air conduits shown.

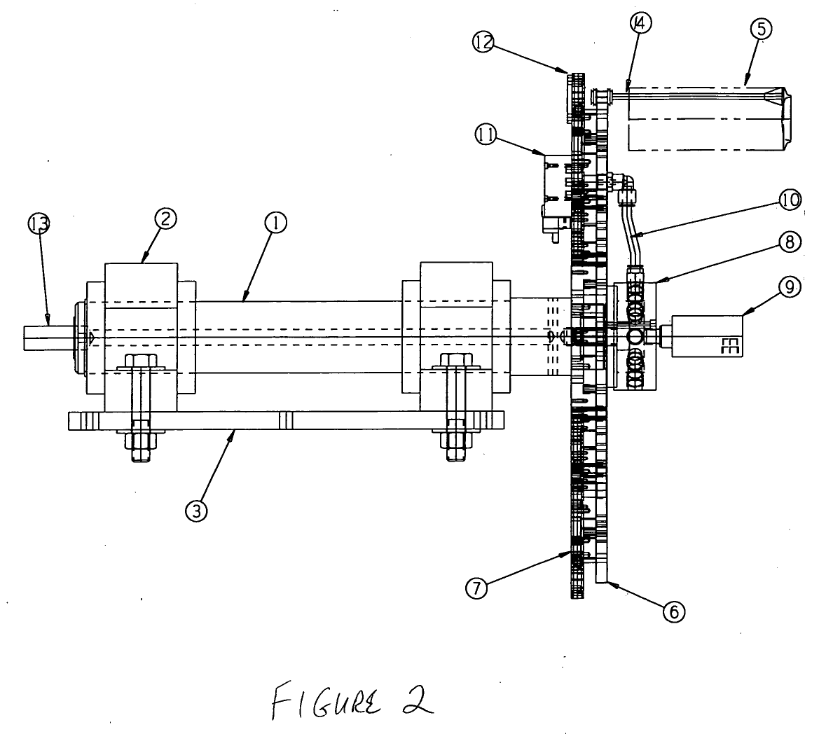

### DETAILED DESCRIPTION OF THE INVENTION

With reference to the drawings, the invention will now be described with regard for the best mode and the preferred embodiment.

The invention is an improved blow-off system for cans, containers or other objects, wherein a directed blast of compressed air is used to eject a defective can from its supporting member, such as a pin mounted onto a pin chain. The air nozzles are structured to move in synchronized manner with the cans as the cans are moved in a single file manner about a circular arc. While the invention will be described in terms of can processing equipment, it is to be understood that the invention may be utilized with other types of containers or objects that are manufactured or processed in rapid, single file manner using a chain conveyor mechanism.

As shown in the drawings, the blow-off system comprises a toothed sprocket 6 that may be of any size and is of the type used as an idler sprocket or drive sprocket in can processing equipment, wherein the cans 5 are advanced in single file manner on a pin chain 4, the openings in the links of the pin chain 4 corresponding to the teeth 16 on the sprocket 6. The sprocket 6 is supported on a hub 7 and affixed to a freely rotating shaft 1 which is restrained axially and rotationally by bearing units 2 mounted to a support plate 3. Each can 5 is supported or retained by a pin or mandrel 14, only one of which is shown for clarity purposes, mounted at evenly spaced intervals on the pin chain 4. As shown, the pin chain 4 passes about the sprocket over an arc of from 90 to 180 degrees.

An array of compressed air nozzles 12 are positioned in a circular arc on the sprocket, the nozzles 12 being spaced to match the spacing of the support pins 14, and such that as the sprocket 6 rotates the compressed air nozzles 12 are aligned with the support pins 14 in synchronized manner. Thus, as each can 5 moves along the pin chain 4 and begins to rotate about the sprocket 6 it will be positioned over one of the compressed air nozzles 12 for the entire 90 to 180 degree arc over which the pin chain 4 is in contact with the sprocket 6. A solenoid or other valving device 11 controls the timing of the compressed air nozzle 12, such that when actuated by a defective can detection means of known type the nozzle 12 will release a strong pulse of compressed air into the can 5, causing it to be blown free of the support pin 14. The compressed air is delivered through a rotary union 9 and then a distribution manifold 8. Each nozzle 12 is combined with a dedicated solenoid valve 11 and dedicated air conduit 10, only one of each being pictured for clarity purposes, such that each nozzle 12 is operable independently of the other nozzles 12. Thus, the manifold 8, air conduits 10, solenoid valves 11 and nozzles 12 all rotate in synchronous motion with the sprocket 6. The control signal to actuate a particular solenoid valve 11 is delivered to the center of the sprocket shaft 1 through a slip ring 13.

In this manner, a given air nozzle 12 moves with the target can 5 over the full arc from 90 to 180 degrees, such that the timing window for achieving ejection is greatly increased in comparison to the timing window for blow-off nozzles that are stationary, which is limited by the width of the can 5 itself.

It is contemplated that equivalents and substitutions for certain elements set forth above may be obvious to those of ordinary skill in the art, and therefore the true scope and definition of the invention is to be as set forth in the following claims.

We claim:

1. A can blow-off system that ejects individual cans from a pin chain moving about a sprocket, the system comprising a plurality of compressed air nozzles mounted onto the sprocket, each said compressed air nozzle aligned with a can carried by the pin chain, each nozzle being individually actuated.

2. The system of claim 1, further comprising an air conduit connecting each of said air nozzles to a distribution manifold.

3. The system of claim 2, further comprising a plurality of valving devices, each valving device dedicated to an individual air nozzle to actuate delivery of compressed air through said air nozzle.

4. The system of claim 3, wherein said valving devices are solenoid valves.

5. The system of claim 2, further comprising a rotary union in communication with said distribution manifold.

6. The system of claim 3, further comprising a rotary union in communication with said distribution manifold.

7. The system of claim 1, wherein said pin chain moves about said sprocket over an arc of from 90 to 180 degrees.

8. A can blow-off system comprising:
a pin chain comprising a plurality of evenly spaced pin supports each adapted to support a can;
a rotating toothed sprocket, said pin chain cooperatively mating with said sprocket over a portion of its circumference;
a plurality of compressed air nozzles positioned on said sprocket, said nozzles spaced so as to match the spacing between said pin supports and each said nozzle synchronized with one of said pin supports as said pin support moves with said sprocket so as to deliver compressed air toward said pin support;
each of said nozzles having a valving device and an air conduit connecting said nozzle to a distribution manifold for delivery of compressed air;
whereby for each said pin support compressed air is delivered through one of said nozzles synchronized with said pin support in response to activation of said valving device so as to eject a can disposed on said pin support.

9. The system of claim 8, wherein said valving devices comprise solenoid valves.

10. The system of claim 8, further comprising a rotary union in communication with said distribution manifold.

11. The system of claim 8, wherein said pin chain moves about said sprocket over an arc of from 90 to 180 degrees.

12. A can blow-off system comprising:
a pin chain comprising a plurality of evenly spaced pin supports each supporting a can;
a rotating toothed sprocket mounted on a shaft, said pin chain cooperatively mating with said sprocket over a portion of its circumference;
a plurality of compressed air nozzles positioned on said sprocket, said nozzles spaced so as to match the spacing between said pin supports and each said nozzle synchronized with one of said pin supports as said pin support moves with said sprocket so as to deliver compressed air toward said pin support;
each of said nozzles having a valving device and an air conduit connecting said nozzle to a distribution manifold for delivery of compressed air to each of said air nozzles independently;
whereby for one of said pin supports compressed air is delivered through one of said nozzles synchronized with said pin support in response to activation of said valving device so as to eject a can disposed on said pin support.

13. The system of claim 12, wherein said valving devices comprise solenoid valves.
